(19) United States
(12) Patent Application Publication
(10) Pub. No.: US 2025/0223061 A1
(43) Pub. Date: Jul. 10, 2025

(54) UNMANNED AERIAL VEHICLE MAINTENANCE STATION

(71) Applicant: DRONEQUBE, INC., Dover, DE (US)

(72) Inventors: Murat MERDIN, Izmir (TR); Oguz Deniz MERDIN, Izmir (TR)

(73) Assignee: DRONEQUBE, INC., Dover, DE (US)

(21) Appl. No.: 18/844,981

(22) PCT Filed: Feb. 28, 2023
(86) PCT No.: PCT/TR2023/050196

§ 371 Date: Sep. 9, 2024

(30) Foreign Application Priority Data
Mar. 7, 2022 (TR) 2022/003395
Jun. 10, 2022 (TR) 2022/009638

(51) Int. Cl. B64U 80/25; B64U 10/14; B64U 50/39; B64U 70/97; B64U 80/10; B64U 80/70; B64U 101/40; B64U 101/45

(52) U.S. Cl. CPC B64U 80/25; B64U 50/39; B64U 70/97; B64U 80/10; B64U 80/70; B64U 10/14; B64U 2101/40; B64U 2101/45

(57) ABSTRACT

A maintenance station for an unmanned aerial vehicle includes a housing having at least one opening for the entry and exit of the unmanned aerial vehicle, at least one platform movable through the opening from the outside to the inside of the housing, at least one robotic arm positioned inside the housing and including a maintenance arm having a holder and/or a filling tube for changing the battery for maintenance of the unmanned aerial vehicle, and at least three adjustment elements that can move toward a common point on the platform to adjust the position of the unmanned aerial vehicle.

### TECHNICAL FIELD

The invention relates to a maintenance station for unmanned aerial vehicles having a closed housing.

### STATE OF THE ART

One of the biggest problems with drones and similar unmanned aerial vehicles is charging times. These vehicles, which have limited charging times, often need to be recharged or new batteries must be added. In addition, unmanned aerial vehicles used for agricultural spraying also need to be filled with pesticides.

Independent maintenance stations have been developed to meet these charging requirements. These maintenance stations include a housing where the unmanned aerial vehicle can land. Charging stations can be located inside said housing. However, since charging times are long, the drone cannot operate during charging and the total equipment efficiency decreases. Considering that charging times are longer than flight times, the drone is charged longer than it flies or waits at maintenance stations with robotic arms that change batteries.

TR2011/11022 describes a platform for landing unmanned aerial vehicles and a system for changing the vehicle's battery. The system comprises battery chambers and a robotic arm for charging and changing batteries. Cameras are also used here for positioning.

U.S. Pat. No. 10,112,712B1 describes a platform for landing unmanned aerial vehicles and a station for charging the vehicle's battery, changing fuel cells, refueling, and using cameras for positioning.

TR2019/13702 relates to a platform for landing unmanned aerial vehicles and a station for changing the vehicle's battery. The system comprises multiple battery chambers, batteries, and an arm that rotates around its axis and moves up and down to change the battery. The robotic arm changes the battery.

Battery changing with robotic arms is a highly sensitive process. If the robot does not move the battery to the correct position and in the correct direction, it is not possible to change the battery, and there is even a possibility of damage to the unmanned aerial vehicle. To solve this problem, the first two prior art documents used cameras to ensure the correct position. However, these systems are known to be expensive and have low accuracy and durability. In the last prior art document, the whole structure is moved to change the battery, but the correct positioning is still not achieved.

It was previously stated that agricultural unmanned aerial vehicles require spraying inputs. In known unmanned aerial vehicle spraying operations, the operator does dosing. In this process, which does not have any control and automation, mistakes can easily be made, resulting in unnecessary or inadequate consumption of agrochemicals. In addition, the occupational health and safety of the operator who has to deal with agrochemicals are at risk. With this method, it is impossible to measure how often and how much pesticide is applied to which location, nor can it be recorded. In addition, there are no models among unmanned aerial vehicles at maintenance stations that can analyze crops and spray at the same time. For this reason, the spraying locations and amounts of unmanned aerial vehicles should be planned before the mission.

As a result, all the problems mentioned above have necessitated innovation in the related field.

### Brief Description and Objects of the Invention

The main object of the present invention is to provide a structure of a maintenance station for unmanned aerial vehicles having a compact unmanned aerial vehicle adjustment mechanism, which has a lower margin of error in operations such as battery and pesticide feeding, and which can also cost less. Accordingly, the maintenance station comprises a housing comprising at least one opening for the entry and exit of the unmanned aerial vehicle, at least one platform movable from the outside to the inside of said housing through the opening, at least one robotic arm, within said housing, having a maintenance arm comprising a holder and/or a filling tube for changing the battery for servicing the unmanned aerial vehicle, and at least three adjustment elements movable towards a common point to adjust the position of the unmanned aerial vehicle on said platform.

Thus, while moving towards a common point, the adjustment elements push the unmanned aerial vehicle that has landed on the platform, and with this pushing motion, the unmanned aerial vehicle is fixed at a predetermined point and moved into the platform and the housing. In this case, since the position of the unmanned aerial vehicle is known precisely, the precision required by the robotic arm is reduced, and maintenance operations can be easily performed.

A preferred embodiment of the invention comprises a drive element for driving the drive elements and a trigger sensor for triggering the drive elements. Accordingly, the landing of the unmanned aerial vehicle is quickly detected, and the adjustment elements are directly activated. Thus, a faster adjustment is achieved and the need for human labor is completely eliminated.

A preferred embodiment of the invention comprises at least two openings and two platforms.

Thus, two unmanned aerial vehicles can land at the station at the same time, and when maintenance of one is completed, the other can be taken into the housing for maintenance.

A preferred embodiment of the invention comprises at least one secondary filling feed for pesticide filling on the housing exterior. Accordingly, only unmanned aerial vehicles requiring pesticides can be filled without entering the housing. This embodiment is also useful when the station is full.

A preferred embodiment of the invention comprises the camera for controlling a pesticide spraying area, a processing unit for determining the type of plant, the type of pesticide and the area to be sprayed based on data it received from the said camera, and communication units for communication between the processing unit and the unmanned aerial vehicle.

Thus, the station is configured to provide a detection function. By determining the correct pesticide type and quantity, both savings and human errors are avoided.

### DESCRIPTIONS OF THE FIGURES DESCRIBING THE INVENTION

In order to better explain the device developed with this invention, the figures used, and the related explanations are as follows.

FIG. 1 shows an isometric view of the maintenance system and the unmanned aerial vehicle with the centering elements turned on. The housing roof is not shown for clarity of the system.

FIG. 1a shows an isometric view of the maintenance system and unmanned aerial vehicle with centering elements turned off.

FIG. 1b shows an isometric view of the maintenance system with the centering elements turned on.

FIG. 1c shows an isometric view of the maintenance system with the centering elements turned off.

FIG. 2 shows the side view of the unmanned aerial vehicle at the entrance of the maintenance system and wherein the housing is transparent.

FIG. 2a shows the side view of the unmanned aerial vehicle in the maintenance system when it is inside the housing.

FIG. 2b shows the side view of the unmanned aerial vehicle at the exit of the maintenance system.

FIG. 3 shows an isometric view of the maintenance system during the filling of the unmanned aerial vehicle.

FIG. 4 shows an isometric view of the robotic arm.

FIG. 5 shows another isometric view of the maintenance system.

### DEFINITIONS OF THE ELEMENTS/PARTS/COMPONENTS OF THE INVENTION

In order to better explain the device developed with this invention, the components and parts in the figures are numbered and the corresponding numbers are given below.
1. Maintenance station
10. Housing
11. Door
11a. Opening
12. Maintenance door
13. Maintenance area
14. Secondary feed
20. Platform
21. Adjustment element
211. Shaft
22. Adjustment guide
23. Slide
24. Guide
30. Robotic arm
31. Maintenance arm
311. Holder
312. Holder end
313. Filling tube
32. First arm
321. First ear
33. Second arm
331. Second end
332. Second ear
34. Third arm
341. Third end
342. Third ear
35. Fourth arm
351. Fourth end
100. Unmanned aerial vehicle
110. Aerial vehicle hull
120. Filling nozzle
P. Battery
R1. First axis
R2. Second axis
R3. Third axis
R4. Fourth axis
R5. Fifth axis
R6. Sixth axis

### DETAILED DESCRIPTION OF THE INVENTION

The invention relates to a maintenance station (1) for unmanned aerial vehicles (100).

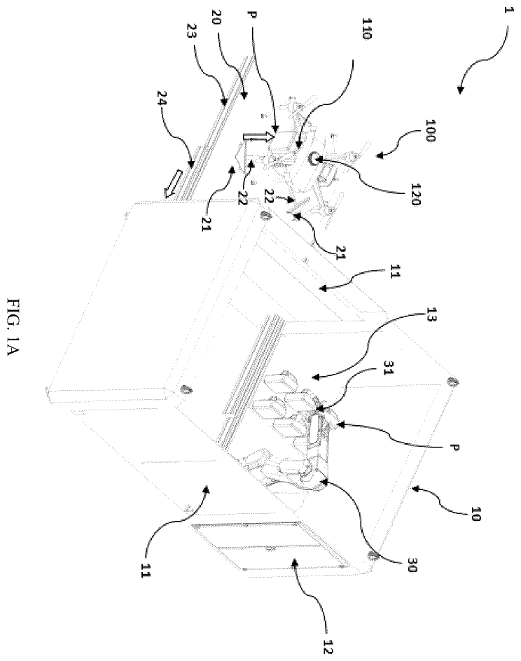

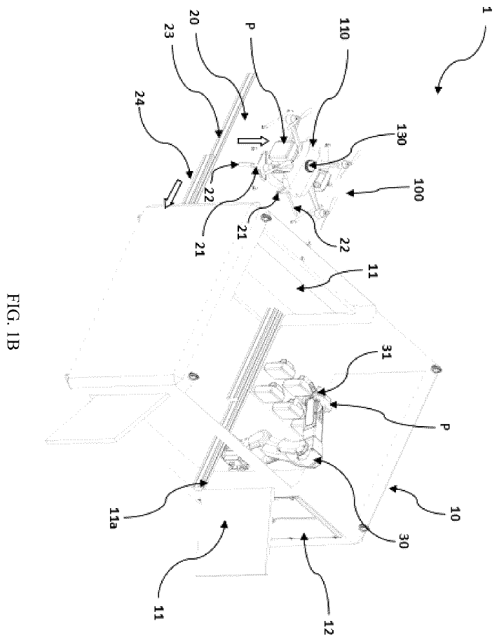

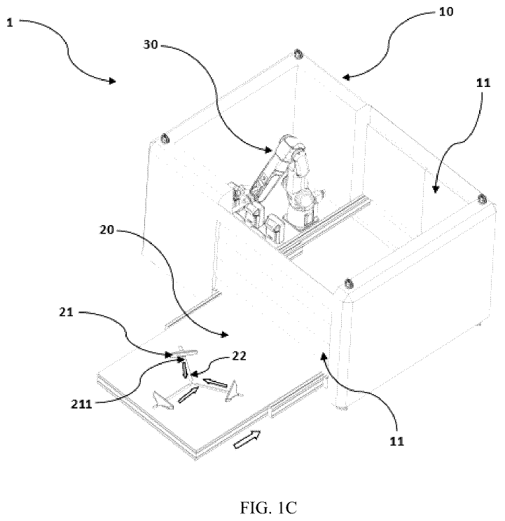

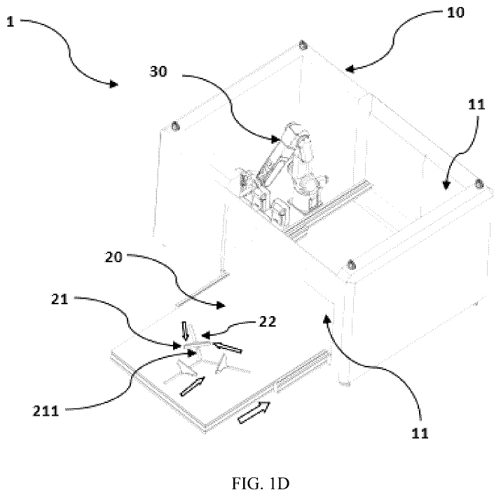

Referring to FIGS. 1 and 1a, the maintenance system (1) is configured for unmanned aerial vehicles (100), in particular vehicles known as drones. An unmanned aerial vehicle (UAV) (100) is a remotely or fully autonomously piloted device, preferably with at least one or preferably multiple propellers. The devices referred to herein comprise at least one battery (P), and the agricultural versions further comprise a filling nozzle (120), preferably at the top of the aerial vehicle body (110), and a spraying system for spraying the filled pesticide.

The maintenance station (1) is configured on housing (10). Said housing (10) is preferably provided in the form of a quadrangular prism. At least one, preferably two, openings (11a) are provided in the housing (10). The openings (11a) allow the unmanned aerial vehicle to enter the housing (10). Said openings (11a) are connected by a door (11). Here, the doors (11) can be pivotally bottom-up, right-to-left opening doors (11), or folding doors (11) are used herein. Preferably, said housing (10) is a completely closed geometry except for the openings (11a).

The maintenance station (1) comprises a platform (20) on which the unmanned aerial vehicle (100) can land. Preferably, the platform (20) is provided in the form of a planar plate. After landing on the unmanned aerial vehicle (100), the platform (20) moves into the housing (10).

Accordingly, the platform (20) comprises at least one, preferably two slides (23) positioned on at least one, preferably two, in particular opposite sides thereof. The housing (10) also comprises guides (24) extending out of the housing (10) corresponding to said slides (23), and the slides (23) are engaged with the guides (24).

With this arrangement, the platform (20) slides in and out of the housing (10) on the guides (24) of the slide (23). Workforce can be used to provide this movement, as well as drive elements such as pistons or motors.

Furthermore, the maintenance station (1) may comprise a second platform. When an unmanned aerial vehicle (100) is inside the housing (10), a second unmanned aerial vehicle (100) may land on this second platform (20). Said second platform (20) can also be connected to the housing (10) by means of a slide (23)-guide (24) cooperation.

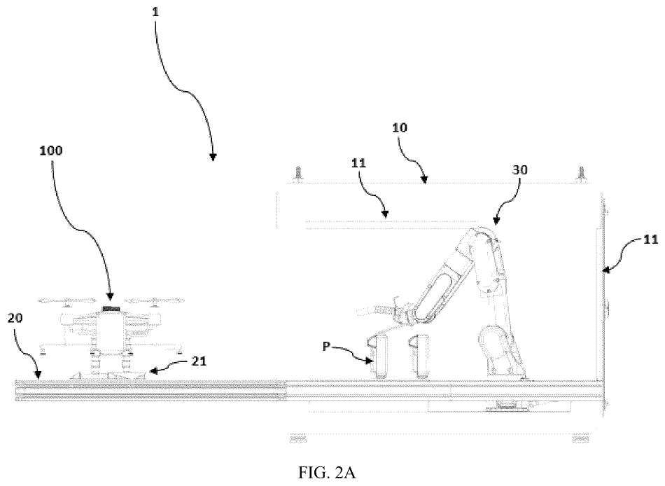

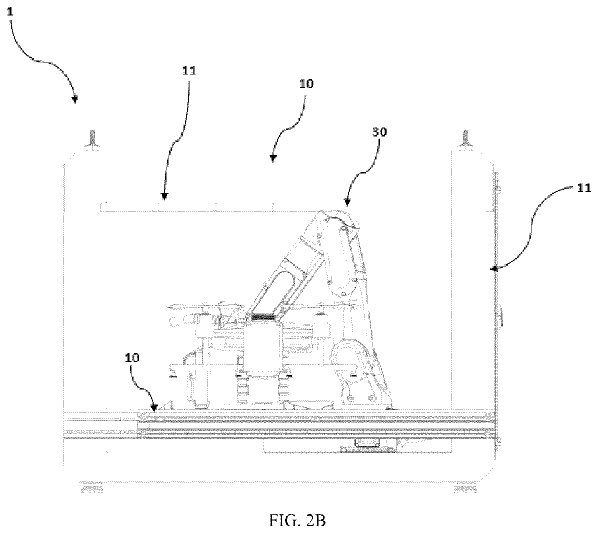

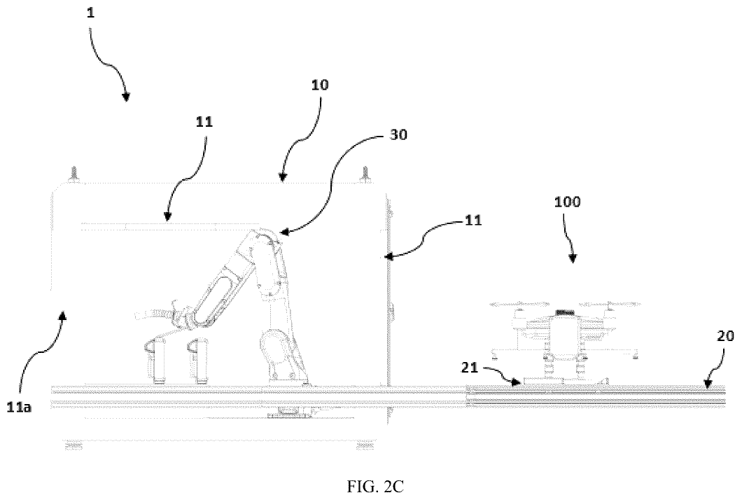

After the maintenance of the unmanned aerial vehicle (100) is completed, it is transported out of the housing (10) on the platform (20) as can be seen in FIG. 2-2b.

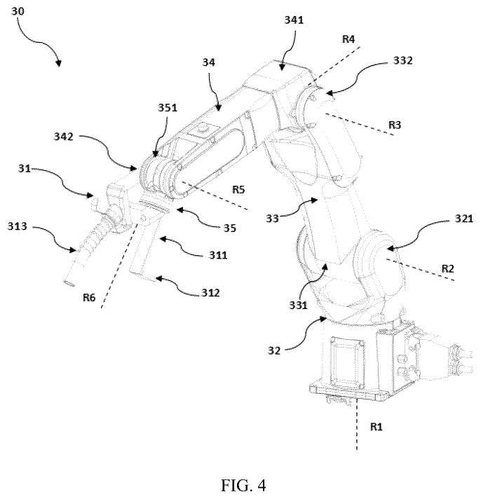

A maintenance area (13) is arranged in the housing (10). A robotic arm (30) is arranged in said maintenance area (13). Said robotic arm (30) comprises a maintenance arm (31). Said maintenance arm (31) comprises both a holder (311) and a filling tube (312) in FIG. 4. Furthermore, embodiments comprising only the holder (311) or only the filling tube (312) can be used as required.

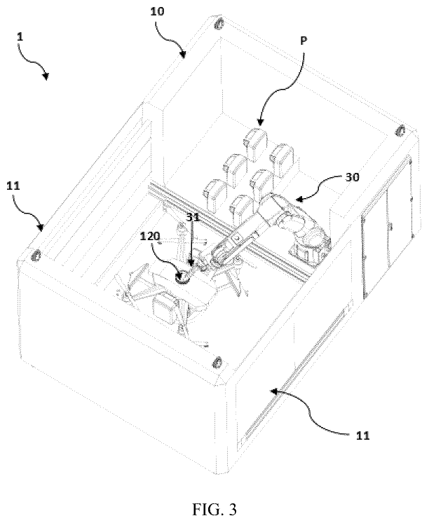

As can be seen in FIG. 3, the robotic arm (30) moves from the maintenance area (13) towards the unmanned aerial vehicle (100) carried by the platform (20). During this movement, the robotic arm can remove the battery (P) of the unmanned aerial vehicle with the holder (311) and insert a new battery (P) back into the unmanned aerial vehicle (100).

In addition, the pesticide can be filled by moving the filling tube (312) onto the filling nozzle (120) in the same motion. Here, the housing (10) may preferably contain at least one and preferably more than one pesticide tank (not shown in the figures). Here, several different types of pesticides can be filled by the robotic arm (30).

For both battery (P) and pesticide filling, the robotic arm (30) must position itself exactly correctly. To facilitate these operations performed by the robotic arm (30), the unmanned aerial vehicle (100) is moved to a predetermined point on the platform (20) after landing.

Referring to FIGS. 1b and 1c, this transport is performed by the adjustment elements (21). The adjustment elements (21) are provided on the said platform (20) and are configured to move together to a common point from different directions. During the movement to the common point, the adjustment elements contact the unmanned aerial vehicle (100) from different directions, thereby pushing the unmanned aerial vehicle (100) to said common point and fixing it thereon. In this way, the exact position of the unmanned aerial vehicle (100) on the platform (20) is known in advance.

Although the geometry of the adjustment element (21) can be provided in different ways, the surface in contact with the unmanned aerial vehicle is provided in a planar shape.

In a preferred embodiment, said adjustment elements (21) are provided on an adjustment shaft (211), and said adjustment shaft (211) is seated in an adjustment guide (22). Preferably, said adjustment guide (22) is provided in a planar shape.

The movement of the adjustment element (21) can be provided by the user, or a motor or piston-like drive element (not shown) can be used to drive the adjustment elements.

In addition, the adjustment elements (21) may also be connected to piston-like drive elements directed toward said common point.

A trigger sensor (not shown in the figures) can be used to prevent said drive elements from operating before the unmanned aerial vehicle (100) lands on the platform (20). Said trigger sensor detects the presence of the unmanned aerial vehicle (100) on the platform (20) and accordingly generates a trigger response. This trigger response triggers the drive element associated with the adjustment element (21), and the adjustment elements (21) accordingly push the unmanned aerial vehicle (100) towards said common point.

Said trigger sensor can be provided as a weight sensor. Said weight sensor is associated with the platform (20) and when the unmanned aerial vehicle (100) lands on the platform (20), the sensor generates a trigger response as the weight of the platform (20) increases.

Alternatively, a presence or proximity sensor can be used as a trigger sensor. Here, the sensor generates a trigger response when the presence of an unmanned aerial vehicle (100) is detected on the platform (20).

Another alternative is to use a camera as a trigger sensor. Here, an image processing unit is required to process the data received from the camera, and a trigger response is generated if the presence of the unmanned aerial vehicle (100) is detected in the processed image.

In another alternative, the unmanned aerial vehicle (100) communicates with the platform (20) via a communication module. This communication can take place before or during the unmanned aerial vehicle (100) lands on the platform. Here, the communication enables the adjustment elements (21) to move by performing the triggering process.

The trigger responses mentioned here can also be used to trigger the drive elements that move the platform.

Referring to FIG. 4, it was previously mentioned that the robotic arm (30) comprises a maintenance arm (31). The maintenance arm (31) comprises a holder (311). The holder (311) comprises a holder end (312) provided at an angle, preferably 90°, relative to a longitudinal body. The holder end (312) functions as a hook to remove the battery (P) from the unmanned aerial vehicle (1) and to insert the new battery (P) from the maintenance area into the unmanned aerial vehicle.

The robotic arm (30) has preferably a six-axis. Accordingly, it comprises a first arm (32) rotating relative to a first axis (R1) perpendicular to the ground. At the end of said first arm (32) are oppositely arranged first ears (321). A second end (331) of a second arm (33) is disposed between said first ears (321), and the second arm (33) is rotatable relative to a second axis (R2) passing through the first ears (321). At the other end of the second arm (33) are the second ears (332). Between these second ears (332) is the third end (341) of the third arm (34) and the third arm (34) can rotate relative to the third axis (R3) passing through the second ears (332). The third arm (34) also rotates relative to a fourth axis (R4) passing through its center and perpendicular to the third axis (R3). At the other end of the third arm (34) are the third ears (342). Between said third ears (342), the fourth end (351) of the fourth arm (35) is located and the fourth arm (35) is rotatable relative to the fourth axis (R4) passing through the third ears (342). The fourth arm (35) also rotates relative to a fifth axis (R5) passing through its center and perpendicular to the fourth axis (R4).

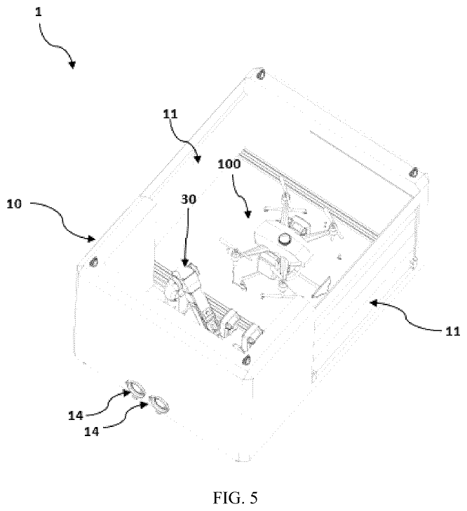

Referring to FIG. 5, on the outer surface of said housing (10) there are secondary feeds (14). The secondary feed (14) is connected to the aforementioned pesticide store. If there is another unmanned aerial vehicle (100) in the housing (10), a second unmanned aerial vehicle (100) will be able to refill pesticides from there.

An embodiment of the invention further comprises the camera for controlling an agricultural spraying area, a processing unit for determining the type of plant, the type of pesticide and the area to be sprayed based on data it received from the said camera, and communication units for communication between the processing unit and the unmanned aerial vehicle (100).

What is claimed is:

1. A maintenance station for an unmanned aerial vehicles, comprising:
a housing of a completely closed geometry except having at least one opening for an entry and an exit of the unmanned aerial vehicle and a door on the at least one opening,
at least one platform movable through the at least one opening from an outside to an inside of the housing,
at least one robotic arm positioned inside the housing and comprising a maintenance arm having a holder for changing a battery and a filling tube for filling a pesticide into a filing port of the unmanned aerial vehicle for a maintenance of the unmanned aerial vehicle, and
at least three adjustment elements configured to move toward a common point on the at least one platform to adjust a position of the unmanned aerial vehicle.

2. The maintenance station according to claim 1, wherein the at least three adjustment elements are distributed at equal angular intervals.

3. A The maintenance station according to claim 1, wherein the at least three adjustment elements are provided on the at least one platform.

4. The maintenance station according to claim 1, further comprising a shaft connected to the at least three adjustment elements and a longitudinal adjustment guide, the shaft is movable in the longitudinal adjustment guide.

5. The maintenance station according to claim 1, further comprising a drive element for driving the at least three adjustment elements.

6. A The maintenance station according to claim 5, further comprising a trigger sensor for triggering the drive element.

7. The maintenance station according to claim 6, wherein the trigger sensor is a weight sensor associated with the at least one platform.

8. The maintenance station according to claim 6, wherein the trigger sensor is a presence or proximity sensor associated with the at least one platform.

9. The maintenance station according to claim 6, wherein the trigger sensor is a camera associated with the at least one platform.

10. The maintenance station according to claim 1, wherein the maintenance station comprises at least two openings.

11. (canceled)

12. The maintenance station according to claim 1, wherein the maintenance station comprises at least two platforms.

13. The maintenance station according to claim 1, further comprising at least one secondary filling feed for filling the pesticide on an outer surface of the housing.

14. A The maintenance station according to claim 1, further comprising a camera for controlling a pesticide spraying area, a processing unit for determining a type of a plant, a type of the pesticide, and an area to be sprayed based on data received from the camera, and communication units for a communication between the processing unit and the unmanned aerial vehicle.

15. The maintenance station according to claim 1, wherein the at least one robotic arm is multi-axis.

16. The maintenance station according to claim 14, wherein the at least one robotic arm has a six-axis.
